(19) United States
(12) Patent Application Publication
(10) Pub. No.: US 2008/0078449 A1
(43) Pub. Date: Apr. 3, 2008

(54) Low Consumption Pneumatic Controller

(76) Inventor: Alexander C. Pesek, Marshalltown, IA (US)

Correspondence Address: MARSHALL, GERSTEIN & BORUN LLP (FISHER), 233 SOUTH WACKER DRIVE, 6300 SEARS TOWER, CHICAGO, IL, 60606, US

(21) Appl. No.: 11/858,430

(22) Filed: Sep. 20, 2007

Related U.S. Application Data
(63) Continuation-in-part of application No. 11/852,786, filed on Sep. 10, 2007.
(60) Provisional application No. 60/827,823, filed on Oct. 2, 2006.

(51) Int. Cl. F15B 5/00

(52) U.S. Cl. 137/85

(57) ABSTRACT

A pneumatic controller for controlling a process advantageously reduces fluid consumption by providing a proportional adjustment to a feedback signal. The pneumatic controller comprises a pneumatic control stage such as a relay, a process pressure detector, and a rack-and-pinion feedback assembly. The a rack-and-pinion feedback assembly provides the proportional adjustment of the feedback signal, thereby reducing the fluid consumption of the pneumatic controller.

### RELATED APPLICATIONS

This invention claims priority as a continuation-in-part of U.S. application Ser. No. 11/852,786, filed Sep. 10, 2007, and this invention claims the benefit of priority of U.S. Provisional Patent Application Ser. No. 60/827,823, filed Oct. 2, 2006, the entire contents of each of which are hereby incorporated herein by reference.

### FIELD OF THE INVENTION

This disclosure relates generally to pneumatic controllers, and more particularly, to an improvement of pneumatic controllers used in process control applications that require very low supply fluid consumption.

### BACKGROUND OF THE INVENTION

Process control systems typically use a supply fluid, such as compressed air or gas, to operate pneumatic process control components within the process control system. In remote locations, Process control systems are also known to use the process media that is being controlled to operate the control system components such as the pneumatic instruments or controllers and control valve actuators. In many process applications, a portion of the pneumatic supply fluid used to operate the control system may be consumed during operation (i.e. the supply gas is exhausted during operation and is not captured or recycled). For example, it is generally known that closed loop pneumatic controllers often use a proportional band valve to adjust a feedback signal within a servo loop of the pneumatic controller. Most proportional band valves are implemented as a pre-settable, three-way valve or a two-way pressure divider that vent or exhaust a portion of the supply fluid to atmosphere.

The amount of supply fluid or gas used to operate a pneumatic controller may be divided into two categories: supply fluid required to work the pneumatic control devices such as a control valve and supply fluid consumed or expended to operate the pneumatic controller. For example, in systems where pressure control is needed, a control loop that includes a control valve and a pneumatic controller may be used. For such a control loop, supply gas is used to actuate or move the control valve and is consumed during operation of the pneumatic controller to generate the pneumatic control signal to actuate the control valve. Any element within the process control loop that exhausts the supply fluid to atmosphere essentially wastes supply fluid in the exhaust. In some process control applications, significant amounts of supply fluid are wasted. As an example, a proportional band valve may exhaust up to eighty percent of the supply gas used to operate the controller.

Depending on the process being controlled, the exhausting of supply gases can be problematic and expensive in certain instances such as in the natural gas industry where the natural gas is used as a supply fluid. Thus, the loss of high value fluids like natural gas can provide significant economic motivation to operators to limit the consumption of the supply fluid. Additionally, the environmental impact of supply fluid leakage and the potential regulatory penalties for exceeding limits for certain types of exhausts or emissions create additional incentives to limit a pneumatic instrument's consumption. Even in non-remote locations where compressed air is used as a supply gas, the exhaust of compressed air from numerous controllers may increase the operational cost and/or size of the compressor required to supply the compressed air.

### SUMMARY OF THE INVENTION

In accordance with one example, a pneumatic controller for controlling a process comprising a pneumatic control stage providing a process control signal to a control element, a pneumatic feedback assembly providing a feedback control signal representative of the process to the pneumatic control stage, wherein the feedback control signal modifies the process control signal and a feedback proportioning means connected to the pneumatic feedback assembly to provides an adjustment to the feedback control signal.

In accordance with another example, a feedback proportioning device for a pneumatic process controller comprises a feedback detector providing a feedback signal representative of a control signal and a cantilever assembly providing a predetermined adjustment of the feedback signal. The cantilever assembly substantially reduces a supply fluid consumption of the pneumatic process controller.

### BRIEF DESCRIPTION OF THE DRAWINGS

The features of this invention which are believed to be novel are set forth with particularity in the appended claims. The invention may be best understood by reference to the following description taken in conjunction with the accompanying drawings wherein like reference numerals identify like elements in the several figures, in which:

FIG. 1 is a graphical representation of an example pneumatic controller comprising a cantilever feedback adjustment;

FIG. 2 is an expanded view of a cantilever feedback adjustment;

FIG. 3 is a graphical representation of an eccentric cam adjuster for a pneumatic controller.

FIG. 4 A is a perspective view of an example rack-and pinion feedback mechanism for a pneumatic controller.

FIG. 4B is a side view of an outboard rack of an example rack-and pinion feedback mechanism.

FIG. 4C is a cross-sectional end view of an example rack-and pinion feedback mechanism.

FIG. 5 is a top view of a cantilever of an example rack-and pinion feedback mechanism.

### DETAILED DESCRIPTION

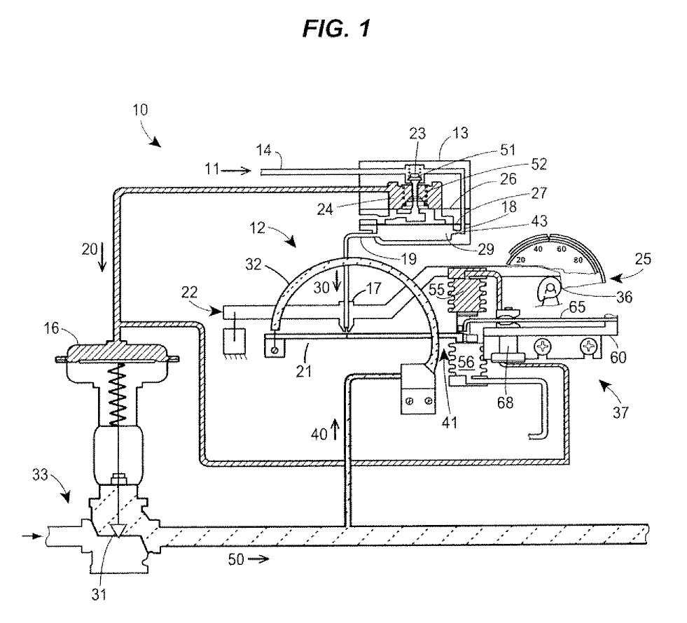

The example pneumatic controller uses a mechanical feedback element to adjust or proportion a feedback signal within a servo control loop to substantially reduce the fluid consumption during operation. With reference to FIG. 1, an example pneumatic controller 10 is described. The pneumatic controller 10 comprises a pneumatic control stage 13, a feedback assembly 12, and a proportional feedback device 37. In one embodiment, the pneumatic control stage comprises a relay 13. The feedback assembly 12 includes a Bourdon tube assembly 32 and a nozzle-flapper assembly 22, which includes a nozzle valve 17 and a summing beam-flapper 21. To operate the controller 10, a supply fluid 11, such as natural gas, is connected to an inlet 14 of the relay 13. The relay 13 provides a pneumatic control stage to drive a control valve actuator 16 with a control pressure 20 to position a flow control element 31 within a control valve 33 which controls a process flow 50 through the control valve 33. The control pressure 20 used to actuate the control valve actuator 16 is derived from a pressure associated with the supply fluid 11 connected to the relay 13 and is determined, in part, by a pneumatic control signal generated from the nozzle-flapper assembly 22.

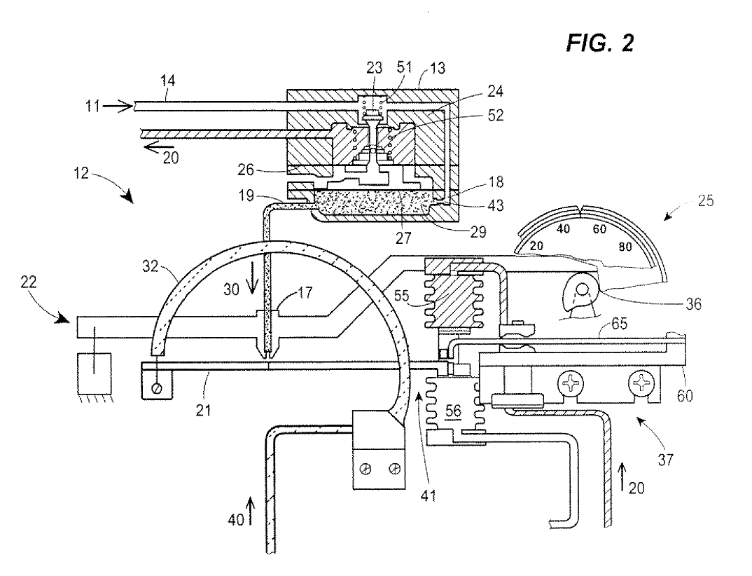

At initial startup of the pneumatic controller 10, an internal relay valve 23 in the relay 13 opens and the supply fluid 11 flows through a relay chamber 24 and a control chamber 29 within the relay 13 to build the control pressure 20 in the actuator 16. As shown in FIG. 2, a pneumatic restriction 43 at an inlet 18 to the control chamber 29 creates a lag or delay during pressurization of the relay chamber 24 and the control chamber 29 to provide fluid flow to the actuator 16 until a predetermined or operational force balance across the relay 13 is achieved, as described herein. During operation, the control pressure 20 results from the modulation of a nozzle pressure 30 by the nozzle-flapper assembly 22 connected to a control inlet 19 of the relay 13 via a pressure shunting action. That is, the relay valve 23 operates across a force balance primarily established by supply fluid pressure 11 acting upon an area ratio of an upper diaphragm 26 and a loading diaphragm 27 in the relay 13 with an additional bias spring force generated by an inlet spring 51 and a relay chamber spring 52. By controlling the nozzle pressure 30 acting upon the loading diaphragm 27, a supplemental force directly related to the nozzle pressure 30 controls the relay valve 23 position, and therefore, the control pressure 20 to the actuator 16.

The shunting action of the nozzle-flapper assembly 22 previously described results from the relative position of the summing beam-flapper 21 with respect to the nozzle valve 17. The changes in relative position in the nozzle-flapper assembly 22 create a variable fluid restriction which causes corresponding changes in nozzle pressure 30. More specifically, the relative position of the nozzle valve 17 with respect to the summing beam-flapper 21 is determined, in part, by a process pressure 40 related to the downstream process fluid flow 50. To sense or detect the process pressure 40, the Bourdon tube assembly 32 is directly connected to the downstream process fluid flow 50. As the Bourdon tube assembly 32 is pressurized, it will expand or contract in correspondence to the changes in process pressure 40. Accordingly, it should be appreciated that an increase in process pressure 40 causes an expansion of the Bourdon tube assembly 32 subsequently moving the summing beam-flapper 21, from the left end designated A, resulting in movement towards the nozzle valve 17, effectively increasing a restriction at the nozzle valve 17, to increase the pressure on the loading diaphragm 27 in the relay 13 which subsequently opens the relay valve 23 creating an increase in the control pressure 20 to the actuator 16. Likewise, a decrease in process pressure 40 allows the Bourdon tube assembly 32 to contract, which moves the summing beam-flapper 21 away from the nozzle valve 17, thereby reducing the restriction presented by the nozzle-flapper assembly 22 and the fluid pressure on the loading diaphragm 27 causing the control pressure 20 to the actuator 16 to decrease. In the example pneumatic controller 10, the Bourdon tube assembly 32 is used as a process feedback detector or element, but one of ordinary skill in the art appreciates that other feedback elements such as a bellows assembly may also be used.

To change the control point of the control valve 33, the pneumatic controller 10 provides an adjustment means 25 connected to the nozzle-flapper assembly 22 to establish a fixed or minimum pressure shunt in the nozzle-flapper assembly 22. That is, a set point of the pneumatic controller 10 is established by adjusting the absolute position of the nozzle valve 17 relative to the summing beam-flapper 21. In the example pneumatic controller 10, a cammed lever device 36 moves the nozzle valve 17 relative to summing beam-flapper 21 to provide the previously described predetermined shunt or “bleed” through the nozzle valve 17. By establishing this predetermined shunt, the nozzle pressure 30 provides a predetermined force on the loading diaphragm 27 to generally fix the control pressure 20 to the actuator 16. It is also generally known that disturbances within the process (i.e. buffeting forces within the valve or changes in flow demand downstream of the valve) may cause deviations in the position of the control element 31 that will affect process control (i.e., open loop control using only the aforementioned set point control is insufficient to control the process). To minimize such disturbances from affecting the process, process controllers provide a means for an adjustable negative feedback in a closed loop control strategy.

Conventional pneumatic controllers often use a proportional band valve connected between the control pressure and atmosphere to ratiometrically proportion or adjust the pressure feedback through a feedback or proportional bellows (i.e., an adjustable negative feedback means). Conventional pneumatic controllers use the proportional band valve as a pressure divider to develop feedback pressure in the proportional band bellows based on a percentage of the controller's output pressure. It is generally understood that changing the setting of the proportional band valve provides for a different percentage of feedback pressure relative to the applied output pressure and ultimately results in a different proportional gain for the controller. The proportional band setting on the controller is used to tune the response of a process loop in response to set point changes and load upsets that occur in the process, but the proportional band valve continuously exhausts the supply fluid to the atmosphere which generally wastes large amounts of supply fluid.

The example pneumatic controller 10 reduces its consumption by replacing the proportional band valve with a cantilever feedback mechanism 60 that provides a proportional band adjustment without the bleed associated with the proportional band valve. As shown in FIGS. 1 and 2, a proportional bellows assembly 41 is pneumatically connected to the control pressure 20 and mechanically attached to the summing beam-flapper 21 as a process control signal detector. The proportional bellows assembly 41 comprises an upper bellows 55 and a lower bellows 56. The upper bellows 55 is connected to the control pressure 20. The lower bellows 56 is vented to atmosphere. As such, the proportional bellows assembly 41 may detect and respond to changes in control pressure 20 to provide a feedback force through the summing beam-flapper 21 to counteract pressure changes at the nozzle valve 17 and equalize a force differential that exists across the relay 13. During operation, changes in control pressure 20 are fed to the proportional bellows assembly 41, which causes a corresponding expansion or contraction of the upper bellows 55 which imparts a feedback force, relative to the right end B of the summing beam-flapper 21 to counteract nozzle valve forces resulting from increases or decreases in the nozzle pressure 30.

To provide “tuning” or optimization of the pneumatic controller response, the cantilever feedback mechanism 60 provides a proportional band adjustment. The proportional band adjustment is based on a reduction, or division, of the motion imparted to the summing beam-flapper 21 through the proportional bellows assembly 41 as a result of a given change in the process pressure 40. It should be appreciated that for a given change in process pressure 40, the upper bellows 55 of the proportional bellows assembly 41 displaces the end of the cantilever feedback mechanism 60 by an amount that is directly proportional to the effective area of the proportional bellows assembly 41 and indirectly proportional to a spring rate or stiffness resulting from the cantilever feedback mechanism 60 in combination with a stiffness in the proportional bellows assembly 41.

The cantilever feedback mechanism 60 provides a proportional band adjustment by changing the effective length, and therefore the spring rate, of a cantilever 65. That is, the effective length of the cantilever 65 is adjusted by moving a proportional band adjuster 68 to a different position. As shown in FIGS. 1 and 2, the proportional band adjuster 68 is a clamping device arranged to slide along the cantilever 65 and may be secured by any means generally known in the art such as a rotating fastener (i.e. a thumb screw arrangement). One skilled in the art should appreciate that various arrangements of the cantilever 65 and the proportional band adjuster 68 may be used to align the two components. For example, a slot traversing the length of the cantilever 65 may accommodate a fastener of the proportional band adjuster 68 or the proportional band adjuster 68 may incorporate a recess (not shown) that “straddles” the cantilever to maintain alignment without departing from the spirit and scope of the example feedback adjustment means.

In tuning the feedback of the pneumatic controller 10, the relocation of the proportional band adjuster 68 causes the stiffness of the cantilever 65 to change as the length of the flexible portion of the cantilever 65 changes. Thus, the combination of the process pressure acting in the proportional bellows assembly 41 and the stiffness supplied by the cantilever 65 results in an adjustable displacement imparted to the summing beam-flapper 21 to control to control pressure 20 to the actuator 16. For example, moving the proportional band adjuster 68 to the right in reference to FIG. 2 reduces the stiffness of the cantilever 65 and results in more displacement of the summing beam-flapper 21 resulting from a change in pressure in the proportional bellows assembly 41. In addition to the modification of displacement due to the above described change in the position of the proportional band adjuster 68, additional amplification may occur to alter the effect of the cantilever's stiffness (i.e., both upper and lower bellows 55 and 56 have an associated spring rate that operates in combination with the stiffness of the cantilever 65).

For example, as the proportional band adjuster 68 is positioned to the right, the effective length of the cantilever 65 is increased. As the effective length of the cantilever 65 is increased, more of the displacement of the proportional bellows assembly 41 directly transfers to the summing beam-flapper 21 yielding a multiplicative effect on the stiffness of the cantilever 65. This increasing feedback may not be directly proportional to the length of the cantilever 65. In fact, this multiplicative effect may be approximately logarithmic with respect to the change in position of the proportional band adjuster 68 and the inherent spring rate of the proportional bellows assembly 41 which may exert an additional force related to the displacement length of the upper bellows 55. A logarithmic relationship may be desirable in the application of the controller as it enhances tuning sensitivity of the proportional gain adjustment when the proportional band becomes large (i.e., feedback supply sensitivity is increased). One of ordinary skill in the art may also appreciate various cantilever arrangements may provide other travel/spring rate relationships such as a “leaf spring” arrangement or a variable thickness or width of the cantilever.

To change the feedback signal in operation, the adjuster 68 is moved along the length of the cantilever 65. As previously described, if the proportional band adjuster 68 is moved all the way to the right of the cantilever 65 in FIG. 27 all of the control pressure 20 change feeds back to the proportional bellows assembly 41. Thus, as the control pressure 20 increases, the proportional bellows assembly 41 will expand and move the summing beam-flapper 21 away from the nozzle 17 to command a decrease in the control pressure 20 from the relay 13. Similarly, when the proportional band adjuster 68 is moved all the way to the left of the cantilever 65, the combined stiffness of the cantilever feedback mechanism 60 and the proportional bellows assembly 41 may resist the process pressure 40 thus decreasing the displacement of the summing beam-flapper 21 from the nozzle. This movement increases nozzle resistance thereby increasing pressure on the loading diaphragm 27 subsequently increasing the control pressure 20. As a result, the example pneumatic controller 10 provides a proportional band adjustment without exhausting supply fluid to the surrounding atmosphere.

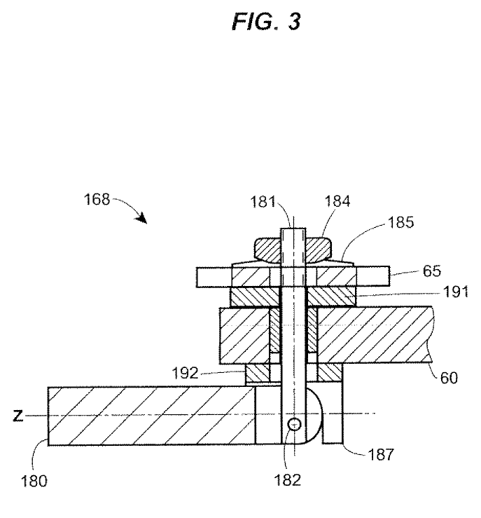

The example pneumatic controller 10 may also provide an alternate means to secure the proportional band adjuster 68 to the cantilever 65. FIG. 3 shows a clamping arrangement to secure a proportional band adjuster to the cantilever 65 without a rotational fastener directly clamping to the cantilever 65. In the locking lever assembly 168, a spring component 185, such as a Belleville spring, provides a mechanical compliance during a camming action to prevent distorting the cantilever 65 or permanently elongating the shaft 181. Similar to the previously described proportional band adjuster, the example locking lever assembly 168 is positioned along the cantilever at the desired position. A locking lever 180 rotates about a pin 182 within an adjuster clamp 187 offset from the central axis, Z, of the locking lever 180. As the locking lever 180 engages the clamp 187 by rotating in a clockwise direction, an adjuster shaft 181 is drawn towards the cantilever 65, compressing the spring 185, to provide a spring biased/compliant load on the cantilever 65 which secures the locking lever assembly 168 in the desired position. Additionally, a pair of spacers 191 and 192 may be provided to avoid damaging the cantilever 65 and provide alignment during engagement of the adjuster clamp 187. To provide a means to adjust the Belleville spring load, an adjusting nut 184 may be threadably attached to the shaft 181 to control the compression depth of the locking lever assembly 168. One skilled in the art may appreciate that other compliant means could also be used to provide the momentary elongation duration the camming action such as a coil spring or a polymer.

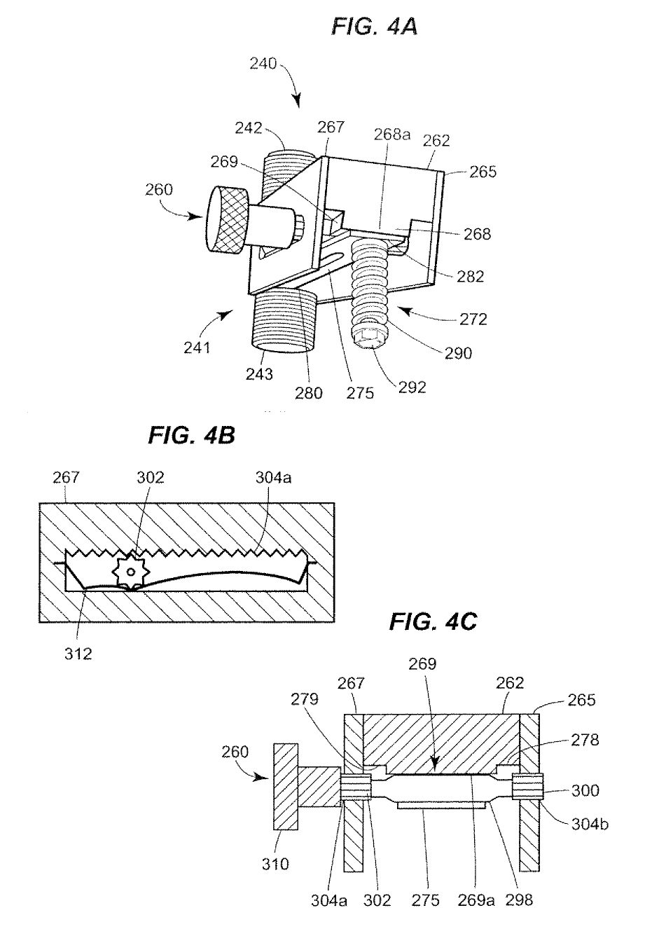

In another embodiment, the example pneumatic controller 10 described above may provide an alternate means to adjust the proportional band. FIG. 4A, 4B, and 4C illustrate a rack-and-pinion feedback mechanism 240 that may be used to adjust the proportional feedback of the pneumatic controller 10. More particularly, FIG. 4A shows a perspective view of one embodiment of a rack-and-pinion feedback mechanism 240 coupled to a bellows assembly 241. The rack-and-pinion feedback mechanism 240 comprises a gain adjustment bar 262, an in board and outboard rack 265, 267, a roller pinion assembly 260, and a bias spring assembly 272. The gain adjustment bar 262 includes a bias portion 268 having a generally T-shaped cross section and a roller portion 269 having a rectangular cross section. The inboard and outboard racks 265, 267 can be attached to the gain adjustment bar 262 by various methods known to those skilled in the art such as a fastener, welding, brazing, an adhesive, or cast as a single, unified piece. The T-shaped bias portion 268 provides a mounting boss 268a for a cantilever 275. A flat surface 269a of the roller portion 269 provides an adjustment surface for the roller pinion assembly 260.

To provide for adjustment of the proportional feedback of the bellows assembly 241, a first end 280 of the cantilever 275 can be operatively coupled between upper and lower bellows 242, 243 of the bellows assembly 241, and a second end 282 of the cantilever can be operatively coupled to the bias portion 268 of the gain adjustment bar 262. The bias spring assembly 272 comprises a bias spring 290 and a bias spring retainer 292, and attaches to the bias portion 268 to fix the second end 282 of the cantilever 275 to the gain adjustment bar 262.

The roller pinion assembly 260 is positioned between the roller portion 269 of the gain adjustment bar 262 and the cantilever 275. As shown in FIG. 4C, the roller pinion assembly 260 includes a roller 298, inboard and outboard pinion gears 300, 302, and an adjustment knob 310. The inboard and outboard pinion gears 300, 302 are connected to the roller 298 and ride along rack gears 304a, 304b formed with the inboard and outboard racks 265, 267, and which position the roller 298 along the roller portion 269 of the gain adjustment bar 262. As shown in FIG. 4B, a leaf spring 312 can be integrally attached between the outboard rack 267 and the outboard pinion gear 302. The leaf spring 312 provides a bias force between the outboard rack 267 and the outboard pinion gear 302 to create positive engagement therebetween. The leaf spring 312 may have a spring rate of preferably 12 lbs/in.

As shown in FIG. 4C, the T-shaped bias portion 268 of the gain adjustment bar 262 provides a clearance recess 278, 279 to receive the pinion gears 300, 302 of the roller pinion assembly 260 without interference. One of ordinary skill in the art should appreciate that the inboard and outboard pinion gears 300, 302 and the rack gears 304a, 304b formed with the inboard and outboard racks 265, 267 are preferably aligned and that the bias spring assembly 272 loads the cantilever 275 against the roller 298 during operation. It should be further appreciated that the relative position of the roller 298 with respect to the bias spring assembly 292 determines the effective length of the cantilever 275, and therefore, the feedback force exerted upon the bellows assembly 241.

As previously described, the proportional band adjustment is based on a reduction, or division, of the motion imparted to the summing beam-flapper through the proportional bellows assembly as a result of a given change in the process pressure. It should be appreciated that for a given change in process pressure, the upper bellows of the proportional bellows assembly displaces the end of the feedback mechanism by an amount that is directly proportional to the effective area of the proportional bellows assembly and indirectly proportional to a spring rate or stiffness resulting from the feedback mechanism in combination with a stiffness in the proportional bellows assembly.

The rack-and-pinion feedback mechanism 240 provides a proportional band adjustment by changing the effective length, and therefore the spring rate, of the cantilever 275. That is, the effective length of the cantilever 275 is adjusted by moving the roller 298 to a different position. One of ordinary skill in the art can appreciate that the position of the roller pinion assembly 260 changes a flexure point of the cantilever 275, changing its effective length thereby causing the stiffness of the cantilever 275 to change as the length of the flexible portion of the cantilever 275 changes. Thus, the combination of the process pressure acting in the proportional bellows assembly 241 and the stiffness supplied by the cantilever 275 results in an adjustable displacement imparted to the summing beam-flapper 21 (FIG. 1) to control the control pressure 20 (FIG. 1) to the actuator 16 (FIG. 1).

For example, rotating the gain adjustment knob 310 clockwise moves the roller to the right in reference to FIG. 4A thereby reducing the stiffness of the cantilever 275 and resulting in more displacement of the summing beam-flapper 21 from a change in pressure in the proportional bellows assembly 241. In addition to the modification of displacement due to the above described change in the position of the roller 298, additional amplification may occur to alter the effect of the stiffness of the cantilever 275 (i.e., both upper and lower bellows 242 and 243 have an associated spring rate that operates in combination with the stiffness of the cantilever 275).

Similar to the previous embodiments, as the effective length of the cantilever 275 is increased, more of the displacement of the proportional bellows assembly 241 directly transfers to the summing beam-flapper 21 (FIG. 1) yielding a multiplicative effect on the stiffness of the cantilever 275. This increasing feedback may not be directly proportional to the length of the cantilever 275. In fact, it should be appreciated by one of ordinary skill in the art that this multiplicative effect may be approximately logarithmic with respect to the change in position of the roller 298 and the inherent spring rate of the proportional bellows assembly 241 which may exert an additional force related to the displacement length of the upper bellows 242. A logarithmic relationship may be desirable in the application of the controller as it enhances tuning sensitivity of the proportional gain adjustment when the proportional band becomes large (i.e., feedback supply sensitivity in increased).

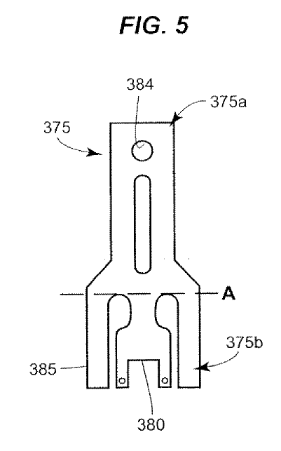

Similarly, when the roller 298 rotated counterclockwise moves all the way to the left of the cantilever 275, the combined stiffness of the cantilever feedback mechanism 240 and the proportional bellows assembly 241 may resist the process pressure 40 (FIG. 1) thus decreasing the displacement of the summing beam-flapper 21 (FIG. 1) from the nozzle. Additionally, when the roller 298 moves all the way to the left of rack-and-pinion feedback mechanism 240 depicted in FIG. 4A, the cantilever 275 may transfer motion to the summing beam-flapper 21 in the opposite direction of the force applied by the bellows assembly 241. One example of a cantilever 375 is illustrated in detail in FIG. 5.

The cantilever 375 has a nested structure having a Y-shape with a first end 375a and a second end 375b. The first end 375a includes an opening 384 for receiving the bias spring assembly 272 and being connected to the gain adjustment bar 262, as depicted in FIG. 4A, for example. The second end 375b includes an inner Y-portion 380 that can be operatively connected to the summing beam-flapper 21 of the pneumatic controller 10 (FIG. 1) and an outer Y-portion 385 that can be operatively coupled to the bellows assembly 41 (FIG. 1). When the roller 298 crosses an axis of the cantilever 375, which is identified by reference character “A” in FIG. 5, the inner Y-portion 380 that is supported by the roller 298 may move in opposition to the outer Y-portion 385 that is acted upon by the bellows assembly 41, which resultantly provides positive feedback in the control loop. This positive feedback will increase the static gain of the controller to a value greater than its forward path gain providing enhanced sensitivity in the control loop and greater integral sensitivity in Proportional-Integral controllers.

While there have been shown and described what are at present considered the preferred embodiments of the present invention, it will be obvious to those skilled in the art that various changes and modifications may be made therein without departing from the scope of the invention as defined by the appended claims. For example. It should also be appreciated that the rack-and-pinion feedback mechanism 240 is positionally independent. That is, the roller pinion assembly 260 depicted in FIG. 4A illustrates the cantilever 275 orientated on the underside of the gain adjustment bar 262 in reference to the example pneumatic controller 10 of FIG. 1. This orientation may be appropriate for a direct act configuration of the example pneumatic controller 10. For a reverse acting configuration, the rack-and-pinion feedback mechanism 240 can be rotated about a longitudinal axis defined by the length of the gain adjustment bar 262 to place the cantilever 275 on the upper side and the roller pinion assembly 260 and which also exchanges the outboard rack 267 for the inboard rack 265. Although certain apparatuses, methods, and articles of manufacture have been described herein, the scope of coverage of this patent is not limited thereto. To the contrary, this patent covers all apparatus, methods, and articles of manufacture fairly falling within the scope of the appended claims either literally or under the doctrine of equivalents.

What is claimed is:

1. A pneumatic controller for controlling a process, the controller comprising:
a pneumatic control stage providing a process control signal to a control element;
a pneumatic feedback assembly providing a feedback control signal representative of the process to the pneumatic control stage, wherein the feedback control signal modifies the process control signal; and
a rack-and-pinion feedback assembly connected to the pneumatic feedback assembly wherein the rack-and-pinion feedback assembly provides an adjustment to the feedback control signal.

2. The pneumatic controller of claim 1, wherein the rack-and-pinion feedback assembly further comprises a bellows assembly.

3. The pneumatic controller of claim 1, wherein the pneumatic control stage comprises a relay.

4. The pneumatic controller of claim 1, wherein the pneumatic feedback assembly further comprises a Bourdon tube and a nozzle-flapper assembly.

5. The pneumatic controller of claim 1, wherein the rack-and-pinion feedback assembly comprises a cantilever and a roller pinion assembly to adjust a stiffness of the cantilever such that the stiffness of the cantilever provides a predetermined feedback control signal.

6. The pneumatic controller of claim 5, wherein the stiffness of the cantilever is proportional to at least one of the length of the cantilever, the thickness of the cantilever, or the width of the cantilever.

7. The pneumatic controller of claim 5, wherein the roller pinion assembly comprises a roller, a pinion gear, and a rack gear.

8. The pneumatic controller of claim 7, wherein the roller pinion assembly further comprises a gain adjustment bar having a bias portion and a roller portion such that a bias spring assembly operatively couples the cantilever to the gain adjustment bar at the bias portion and a position of the roller along the roller portion adjusts the stiffness of the cantilever.

9. The pneumatic controller of claim 1, wherein the rack-and-pinion feedback assembly substantially reduces a supply fluid consumption of the pneumatic controller.

10. A feedback proportioning device for a pneumatic process controller having a pneumatic control stage and a pneumatic feedback assembly, the feedback proportioning device comprising:
a feedback detector providing a feedback signal representative of a control signal produced by the pneumatic control stage; and
a rack-and-pinion assembly providing a predetermined adjustment of the feedback signal.

11. The feedback proportioning device of claim 10, wherein the feedback detector comprises a bellows assembly.

12. The feedback proportioning device of claim 11, wherein the rack-and-pinion assembly includes a cantilever and a roller pinion assembly.

13. The feedback proportioning device of claim 12, wherein the predetermined adjustment of the rack-and-pinion assembly comprises changing a stiffness of the cantilever.

14. The feedback proportioning device of claim 13, wherein stiffness of the cantilever is directly related to at least one of the length of the cantilever, the thickness of the cantilever, or the width of the cantilever.

15. The feedback proportioning device of claim 14, wherein the length of the cantilever is determined by a position of the roller pinion assembly with respect to the bellows assembly.

16. The feedback proportioning device of claim 12, wherein the roller pinion assembly comprises a roller, a pinion gear, and a rack.

17. The feedback proportioning device of claim 16, wherein the roller pinion assembly further comprises a gain adjustment bar having a bias portion and a roller portion such that a bias spring assembly operatively couples the cantilever to the gain adjustment bar at the bias portion and a position of the roller along the roller portion adjusts the stiffness of the cantilever.

18. The feedback proportioning device of claim 14, wherein the stiffness of the cantilever provides a logarithmic relationship relative to a displacement of the bellows assembly.

19. A pneumatic controller, comprising:
a pneumatic relay adapted to provide a control pressure to a control element of a fluid control device;
a nozzle valve fluidly coupled to the pneumatic relay for providing a feedback control signal to the pneumatic relay, the feedback control signal adapted to adjust the control pressure;
a summing beam-flapper disposed in proximity to the nozzle valve and adapted to be displaced relative to the nozzle valve for adjusting the feedback control signal provided to the pneumatic relay;
a bellows assembly operatively coupled to the summing beam-flapper and in communication with the control pressure, the bellows assembly adapted to displace the summing beam-flapper in response to changes in the control pressure;
a cantilever coupled to the bellows assembly for limiting the displacement of the summing beam-flapper;
a rack coupled to the cantilever; and
a roller carried by the rack and in engagement with the cantilever, the roller movable relative to the cantilever to adjust an effective length and stiffness of the cantilever.

20. The controller of claim 19, further comprising a rack gear carried by the rack and a pinion gear carried by the roller, the pinion gear engaging the rack gear.

21. The controller of claim 19, further comprising an adjustment knob coupled to the roller for adjusting the position of the roller relative to the cantilever, thereby adjusting the stiffness of the cantilever.

22. A feedback proportioning device for a pneumatic process controller, the pneumatic process controller comprising a pneumatic relay for providing a control pressure to a fluid control device and a nozzle-flapper assembly in communication with the pneumatic relay for adjusting the control pressure, the feedback proportioning device comprising:
a bellows assembly in communication with the control pressure and connected to the nozzle-flapper assembly;
a cantilever operatively coupled to the bellows assembly to limit a displacement of the bellows assembly;
a rack fixed to an end of the cantilever; and
a roller carried by the rack, the roller engaging the cantilever and adapted to be moved relative to the rack to adjust the effective length and stiffness of the cantilever.

23. The device of claim 21, further comprising a rack gear carried by the rack and a pinion gear carried by the roller, the pinion gear engaging the rack gear.

24. The device of claim 21, further comprising an adjustment knob coupled to the roller for adjusting the position of the roller relative to the cantilever, thereby adjusting the stiffness of the cantilever.
